(19) United States
(12) Patent Application Publication
(10) Pub. No.: US 2005/0184438 A1
(43) Pub. Date: Aug. 25, 2005

(54) Fast adjustment front fork shock absorber

(76) Inventor: Chin-Sung Tsai, Hsin Chuang City (TW)

Correspondence Address: Jackson Walker L.L.P.;Suite 2100, 112 E. Pecan Street, San Antonio, TX, 78205, US

(21) Appl. No.: 10/784,701

(22) Filed: Feb. 23, 2004

(51) Int. Cl. F16F 9/34

(52) U.S. Cl. 267/166

(57) ABSTRACT

A shock absorber adapted for a bicycle front fork includes a bolt, a driving rod extending into and securely received in an open end of the bolt, two resilient elements movably mounted around the bolt and a knob securely engaged with a free end of the driving rod to drive the driving rod and the bolt to rotate such that the two resilient elements are extended or compressed on the bolt in opposite directions.

### BACKGROUND OF THE INVENTION

1. Field of the Invention

The present invention relates to a shock absorber, and more particularly to a shock absorber for use with a bicycle front fork. With a bolt inside the shock absorber, the user is able to readily adjust the damping effect of the shock absorber and consequently have the damping effect doubled by a single adjustment.

2. Description of Related Art

A conventional shock absorber equipped to the bicycle front fork usually has a cylinder with fluid inside the cylinder or a resilient element compressibly received in the cylinder. When adjustment of the shock absorber damping effect is required, the user normally rotates a knob to change the fluid path inside the cylinder or alter the length of the resilient element such that the damping effect is changed according to the predetermined requirement.

This kind of adjustment requires the user to adjust each and every one of the shock absorber and still the damping effect is not good enough to meet the requirements. Even through the damping effect is enough to deal with the terrain, the effort and time required to complete the adjustment is enormous.

To overcome the shortcomings, the present invention tends to provide an improved fast adjustment shock absorber to mitigate the aforementioned problems.

### SUMMARY OF THE INVENTION

The primary objective of the present invention is to provide an improved shock absorber having a bolt with two different screws formed on an outer periphery of the bolt such that a single adjustment of the shock absorber is able to simultaneously compress or extend two resilient elements mounted on the bolt and thus the damping effect is doubled.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the shock absorber of the present invention;

FIG. 2 is a perspective view showing the assembled shock absorber of the present invention;

FIG. 3 is a cross sectional view of the shock absorber of the present invention by taking line 3-3 in FIG. 2; and

FIGS. 4 and 5 are schematic cross sectional views showing the adjustment of the shock absorber of the present invention.

### DETAILED DESCRIPTION OF THE PREFERRED EMBODIMENT

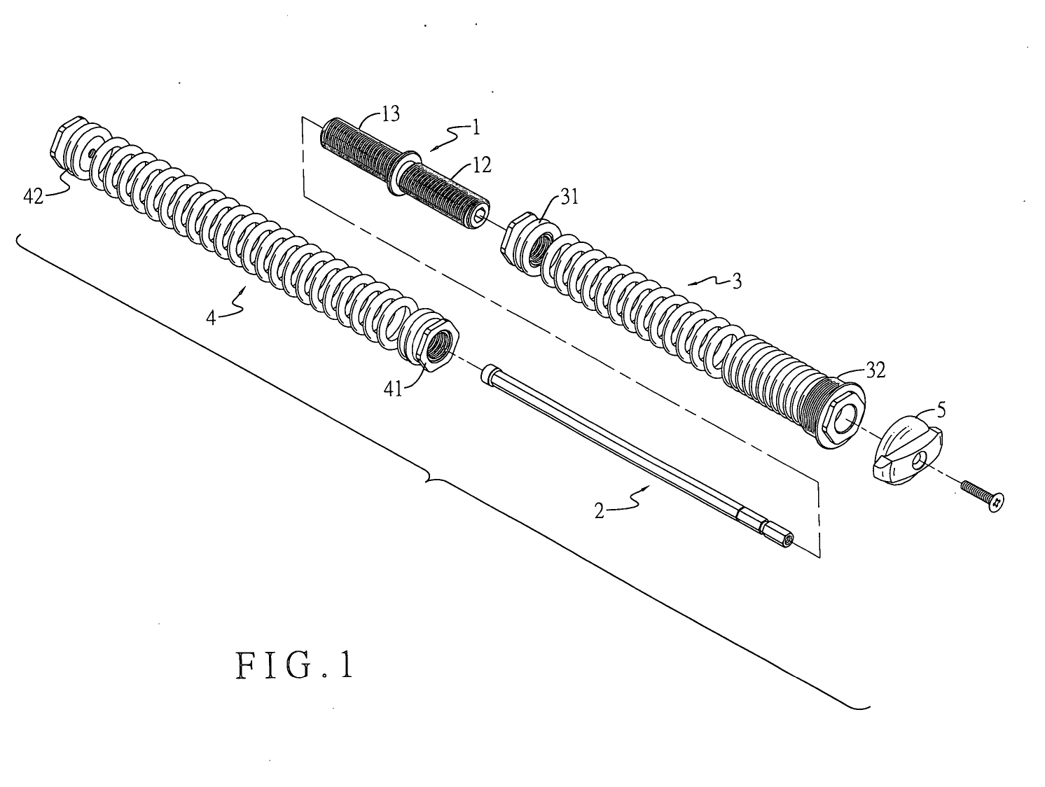

With reference to FIG. 1, the shock absorber in accordance the present invention includes a bolt (1), a driving rod (2), two resilient elements (3,4) and a knob (5).

The bolt (1) has a flange (11) formed on a mediate portion of the bolt (1), a first screw (12) and a second screw (13) both formed on an outer periphery of the bolt (1) and separated from each other by the flange (11). It is noted that the first screw (12) is a right-hand screw and the second screw (13) is a left-hand screw. That is, the rotational directions of the first and the second screws (12,13) are opposite.

The driving rod (2) is able to extend into an open end of the bolt (1) and is so configured that after the driving rod (2) is extended into and received in the bolt (1), there is no relative movement between the driving rod (2) and the bolt (1).

Both resilient elements (3,4) are structurally the same and respectively have a first nut (31,41) securely mounted on a first end of the resilient elements (3,4) and a second nut (32,42) mounted on a second end of the resilient elements (3,4).

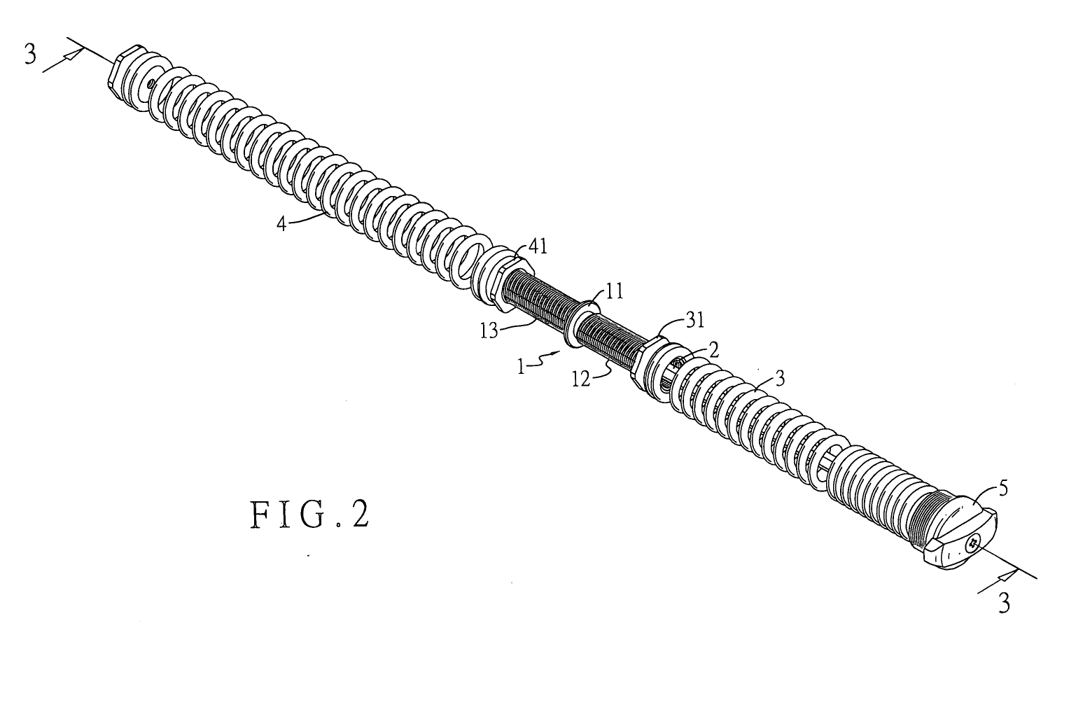

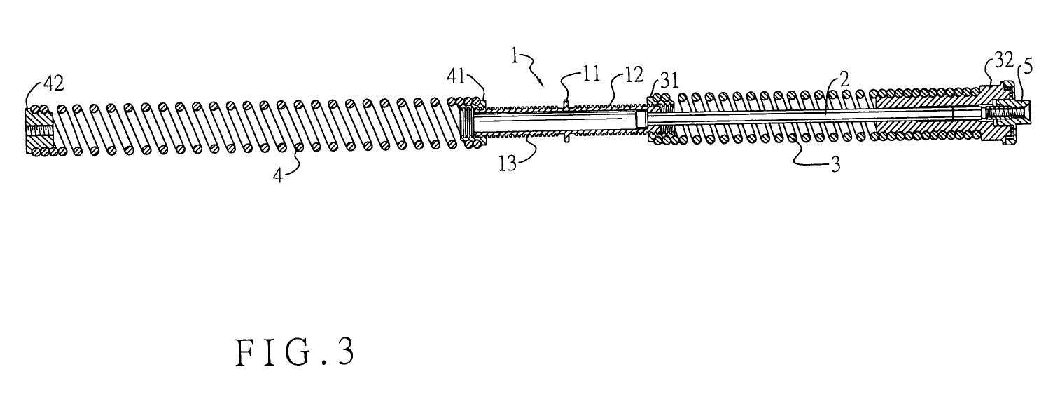

With reference to FIGS. 2 and 3, when the shock absorber of the present invention is assembled, it is noted that the driving rod (2) is securely received in the bolt (1). The first nuts (31,41) of the two resilient elements (3,4) are respectively and threadingly mounted on the bolt (1) and opposite to each other. The knob (5) is then securely engaged with a free end of the driving rod (2) and encloses one of the second nut (32).

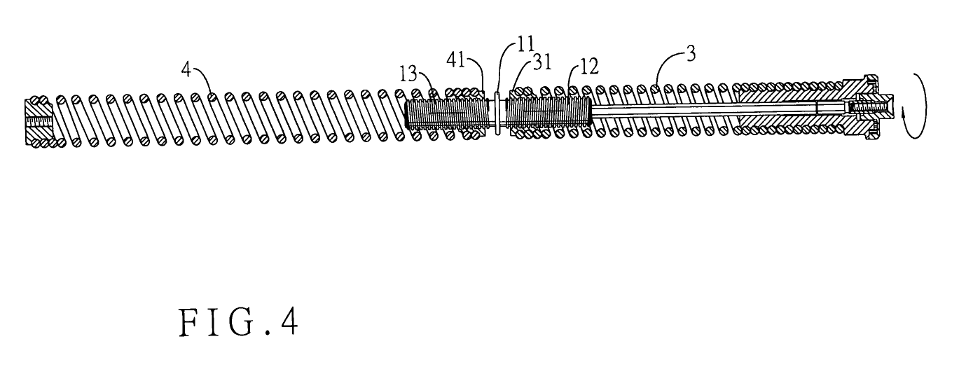

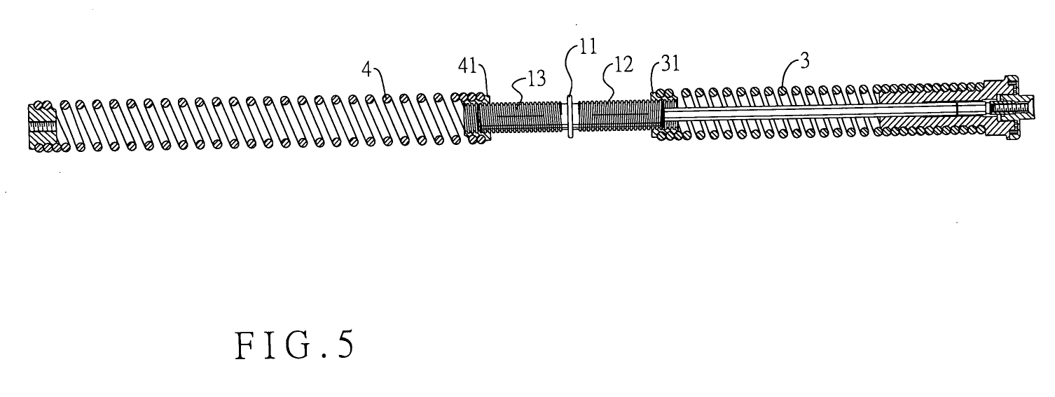

With reference to FIGS. 4 and 5, after assembly, it is noted that rotation of the knob (5) is able to drive the driving rod (2) to rotate simultaneously. Due to the secure engagement between the driving rod (2) and the bolt (1), the bolt (1) is driven to rotate. However, because the first nuts (31,41) are respectively mounted on the first screw (12) and the second screw (13), which have different rotational directions, the rotation of the bolt (1) will therefore drives the first nuts (31,41) to move toward or away from the flange (11) after the first nuts (31,41) and the second nuts (32,42) are securely fixed. Therefore, the simultaneous moving toward or away from the flange of the two resilient elements (3,4) causes the extension or compression of the two resilient elements (3,4). As a result, via only rotating the knob (5), the user is able to have the two resilient elements (3,4) compressed or extended and thus the damping effect is fast adjusted to the terrain.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A shack absorber adapted for a bicycle front fork, the shock absorber comprising:
a bolt;
a driving rod extending into and securely received in an open end of the bolt;
two resilient elements movably mounted around the bolt; and
a knob securely engaged with a free end of the driving rod to drive the driving rod and the bolt to rotate such that the two resilient elements are simultaneously extended or compressed on the bolt in opposite directions.

2. The shock absorber as claimed in claim 1, wherein the bolt has a flange formed on a mediate portion of the bolt, a first screw and a second screw are both formed on an outer periphery of the bolt, a rotational direction of the first screw is opposite to a rotational direction of the second screw.

3. The shock absorber as claimed in claim 1, wherein each of the two resilient elements is equipped with a first nut firmly connected to a first end of each of the resilient elements and threadingly and movably mounted on the bolt so that the two resilient elements are able to extend or compress in opposite directions as the knob is rotated,
each first nut of the two resilient elements is immovable relative to the two resilient elements.

4. The shock absorber as claimed in claim 2, wherein each of the two resilient elements is equipped with a first nut firmly connected to a first end of each of the resilient elements and threadingly and movably mounted on the first screw and the second screw of the bolt so that the two resilient elements are able to extend or compress in opposite directions as the knob is rotated,
each first nut of the two resilient elements is immovable relative to the two resilient elements.

5. The shock absorber as claimed in claim 3, wherein each of the two resilient elements is equipped with a second nut firmly connected to a second end of each of the resilient elements and movable relative to the two resilient elements so that the two resilient elements are able to extend or compress in opposite directions as the knob is rotated.

6. The shock absorber as claimed in claim 4, wherein each of the two resilient elements is equipped with a second nut family connected to a second end of each of the resilient elements and movable relative to the two resilient elements so that the two resilient elements are able to extend or compress in opposite directions as the knob is rotated.
